(19) United States
(12) Patent Application Publication
(10) Pub. No.: US 2026/0115623 A1
(43) Pub. Date: Apr. 30, 2026

(54) DIVIDING WALL COLUMN FOR EFFICIENT HYDROCARBON SEPARATION

(71) Applicants: Minaz Ramjanali Makhania, Gurgaon (IN); Rahul Radhakrishna Pillai, Manvel, TX (US); Rajeev Ranjan, Dwarka (IN); Shouvik Sarkar, Uttar Pradesh (IN)

(72) Inventors: Minaz Ramjanali Makhania, Gurgaon (IN); Rahul Radhakrishna Pillai, Manvel, TX (US); Rajeev Ranjan, Dwarka (IN); Shouvik Sarkar, Uttar Pradesh (IN)

(73) Assignee: KELLOGG BROWN & ROOT LLC, Houston, TX (US)

(21) Appl. No.: 19/367,037

(22) Filed: Oct. 23, 2025

Related U.S. Application Data
(60) Provisional application No. 63/711,320, filed on Oct. 24, 2024.

(51) Int. Cl. B01D 3/32; C10G 9/36

(52) U.S. Cl. CPC B01D 3/32; C10G 9/36; C10G 2300/1044; C10G 2300/807; C10G 2400/02

(57) ABSTRACT

A hydrocarbon separation system comprising a dividing wall column is disclosed. The dividing wall column having feed section, top section, bottom section, and side draw section. The top section may be configured to fractionate top product components to produce the first hydrocarbon fraction process stream containing C3 hydrocarbons. The side draw section may be configured to fractionate the second hydrocarbon fraction process stream containing C4 hydrocarbons and the bottom section may be configured to fractionate bottom product consisting of C5+ components to produce natural gasoline (NG) product stream. Corresponding process and apparatus for separation of hydrocarbon feed are disclosed.

### CROSS REFERENCE TO RELATED APPLICATION

This application claims priority to U.S. Provisional Patent Application having Ser. No. 63/711,320 filed on Oct. 24, 2024 which is incorporated by reference herein.

### FIELD OF THE INVENTION

The present disclosure relates to separation of hydrocarbons. More particularly, it relates to a dividing wall column (DWC) for separation of hydrocarbons in a steam cracker.

### BACKGROUND OF THE INVENTION

Steam cracking is a petrochemical process used to convert hydrocarbons into smaller, often unsaturated hydrocarbons. For example, butane is a common feedstock for steam cracking to produce olefins, such as ethylene and propylene.

A conventional separation scheme involving steam cracking and recovery of hydrocarbons is illustrated in FIG. 1. Various feeds ranging from ethane to gas oils may be fed to a steam cracker unit. Cracking furnaces 50 are adapted receive the feed and depending on the type and conditions of the feed, feed preheat is provided to heat the feed to suitable temperature before introducing to the cracking furnaces 50.

The feed preheat mostly uses heat from other process streams, thereby reducing the overall heat requirement in the process. The generation of the desired olefins from the hydrocarbon feed is carried out in pyrolysis furnaces 50 (also known as heaters and sometimes also referred to as cracking reactors), in which the hydrocarbon molecules are broken down to olefins and other products by thermal energy. Various parameters including but not limited to a residence time and a partial pressure of the hydrocarbon is set by the furnace design and is tuned towards maximization of the olefins products.

A pyrolysis fractionator along with a quench tower 56 make efficient use of heat recovered from the cracked gas by circulating quench oil and quench water that are thermally integrated with the rest of the separation section. Efficient use of this low-level heat reduces steam consumption and cooling water requirements.

The pyrolysis fractionator is adapted for separation of the pyrolysis tars from the cracked gas in a flash zone. Quench sections of the Pyrolysis Fractionator provide the required heat transfer. A water quench tower 56 removes low level heat from the total furnace effluent and begins the step of condensing and recovering the dilution steam as condensate. In addition to serving as a direct-contact heat exchanger to remove heat and to separate the heavy components from the cracked gas before it enters the compression section, the quench tower 56 is designed to act as the first stage suction drum for the Cracked Gas Compressor, CGC 58, saving the cost of a separate suction drum.

A CGC 66, incorporates multiple stages of compression for the cracked gas with low discharge temperatures. The final compressor stage is integrated with the overhead circuit of the Depropanizer 64. This permits operation of the Depropanizer at low pressure without the energy penalties associated with condensing reflux at low pressure. The caustic tower 60 is provided to remove the carbon dioxide and hydrogen sulfide from the furnace effluent Further, removal of water vapor from cracked gas is performed using a dryer 62. The removal of water is necessary to prevent formation of ice and hydrates in low temperature equipment downstream of the dryers 62.

After drying, the cracked gas is fed to the depropanizer 64 which separates a C3- and lighter hydrocarbon stream from C4 and heavier rich hydrocarbon stream, is placed upstream from a debutanizer 78. The C4-rich hydrocarbon stream leaving the depropanizer 64 is sent to the debutanizer 78 in which the C4 hydrocarbons are separated from the C5 and heavier containing pyrolysis gasoline stream. The C4 rich hydrocarbon overhead of the debutanizer 78 is then sent for further processing or as Mixed C4 product from the steam cracker.

To further optimize the process, the depropanizer 64 is split in two columns—a High Pressure Depropanizer 64 which performs the separation of C2 and lighters from the C3 and heavies followed by a Low Pressure (LP) Depropanizer 82 which makes the sharper cut between C3s and C4s and heavies as shown in FIG. 1.

The bottoms of the LP Depropanizer 82 is fed to the Debutanizer 78 which separates C4s as the top product and C5s and heavies as the bottom product. Further, a front-end acetylene reactor 68 selectively hydrogenates C2 and part C3 acetylenes contained in the C3-and-lighter portion of the cracked gas. The acetylene reactor 68 selectively converts all the acetylene to ethylene and ethane, and most of the methyl acetylene and propadiene, to propylene and propane.

The cracked gas is fed to a Demethanizer 92 that utilizes feed flash drums to produce pre-fractionated feeds, reducing the reflux requirements and energy consumption.

The Demethanizer 92 overhead utilizes a turbo-expander to generate low temperature refrigeration to minimize ethylene losses to the tail gas. Heat integration between the Demethanizer 92 and a C2 purification system 84 minimizes the use of ethylene refrigeration, resulting in an Ethylene Compressor 74 that has lower horsepower, and therefore, lower cost.

Finally, the Demethanizer 92 is reboiled by subcooling propylene refrigerant liquid. This assists in maximizing refrigeration recovery which results in a lower horsepower requirement for the propylene compressor and translates to a lower cost for the compressor. A portion of the ethylene product is taken as the overhead product from the Deethanizer 88. A side draw from the Deethanizer 88 is routed to a C2 Splitter, which operates at low pressure to reduce the energy required for the separation. The Deethanizer 88 and the C2 Splitter 86 are integrated with the Ethylene Compressor 74 and produces ethylene product, free from contaminants such as hydrogen, methane, and carbon monoxide.

It should be noted that the separation of C3s, C4s, C5+ is carried out using two separate columns such as the LP depropanizer 82 and the debutanizer 78, as depicted in the FIG. 1. The bottom stream from the HP depropanizer 64 is fed to the LP depropanizer 82. The LP depropanizer 82 makes the final C3/C4+ separation to meet the C3 specification in distillate and bottom products. The overhead vapor from the LP depropanizer 82 is condensed with 7° C. Propylene refrigerant in the LP depropanizer 82 condenser and a portion of the condensed liquid is used as reflux for the LP depropanizer 82 and remaining distillate which is crude C3s is sent for further separation. The LP depropanizer 82 is reboiled using desuperheated low pressure stream and the reboiling rate is adjusted to meet the bottoms C3s content. Any non condensable vapors are recycled back to the process. The LP depropanizer 82 tower bottom is routed to the debutanizer 78 for C4s and heavies separation.

The debutanizer 78 is a conventional distillation tower designed to fractionate the LP depropanizer 82 bottoms stream into a mixed C4s stream and C5 and heavier stream. The mixed C4s from the overhead of the debutanizer 78 are exported. The C5s from the bottom of the debutanizer 78 is exported to outside battery limits of the steam cracker.

The overhead of the debutanizer 78 is condensed and slightly subcooled against cooling water in the debutanizer 78 condenser. The liquid distillate from the debutanizer reflux drum is partly used to reflux the column and the remaining distillate which is the raw C4s stream is sent to OSBL. The debutanizer 78 is reboiled using Desuperheated Low Pressure stream in debutanizer reboiler.

However, there are significant capital and maintenance costs with building a steam cracking unit in which the system for separation of hydrocarbons has this two depropanizer 82/debutanizer 78 column design, which can create an economic barrier to building systems for light olefins production.

It is always desirable to improve the hydrocarbon separation processes and systems by improving efficiency, reducing utility and energy requirements, enhancing plant safety, reducing capital requirements, reducing equipment footprint requirements, and/or improving the value of the products.

### SUMMARY

Examples of a Dividing Wall Column for efficient hydrocarbon separation as described herein can substantially obviates one or more of the problems due to limitations and disadvantages of the related art or at least to provide the public with a useful alternative.

In examples, the system and process described herein may provide improved separation or processing of hydrocarbon streams such as resulting from a catalytic cracking process designed or operated for obtaining increased amounts of light olefins.

In examples, the system and process as described may overcome one or more of the problems described above.

In examples, the functions of Low Pressure (LP) depropanizer and debutanizer of the prior art may be combined into a single fractionation column.

The prior art generally fails to provide the desired separation in an energy efficient manner and also requires higher capital to implement.

In examples, there is provided, a hydrocarbon separation system which includes a cracking furnace. The cracking furnace may be configured to receive a hydrocarbon feed and to produce a reactor effluent. The hydrocarbon separation system may include a Low Pressure (LP) Depropanizer and a Debutanizer implementing a dividing wall column. The dividing wall column having a feed section, a top section, a bottom section, and a side draw section, where the feed section may be configured to receive and to partially fractionate C3 and heavies hydrocarbon stream. In this context, heavies hydrocarbon stream is considered as the one with more than 6 carbon atoms and light hydrocarbon stream is considered as the one with 1 to 6 carbon atoms. The top section may be configured to fractionate top product components from middle product components and to produce the first hydrocarbon fraction process stream containing C3 hydrocarbons. The side draw section may be configured to fractionate the second hydrocarbon fraction process stream containing C4 hydrocarbons and the bottom section may be configured to fractionate bottom product components from middle product components and to produce a natural gasoline (NG) product stream.

In some embodiments, the LP depropanizer and/or debutanizer implementing the dividing wall column may have an operating pressure from 8 bars to 3 bars.

In examples, there is provided a process for separating hydrocarbon feed. The process may include introducing a hydrocarbon feed to a cracking reactor to produce an effluent and fractionating the effluent using a LP Depropanizer and/or a Debutanizer implementing a dividing wall column, wherein the dividing wall column having a feed section, a top section, a bottom section, and a side draw section. Further, the process may include operating the LP Depropanizer and/or the debutanizer with a dividing wall such that C3 and heavies hydrocarbon stream passes from the feed section, a first hydrocarbon fraction process stream containing C3 hydrocarbons passes from the top section, a second hydrocarbon fraction process stream containing C4 hydrocarbons passes from the side draw section, and a natural gasoline (NG) product stream passes from the bottom section.

In examples, the LP depropanizer and/or the debutanizer implementing the dividing wall column may be operated with an operating pressure from 8 bars to 3 bars.

In some examples, the dividing wall column may include a pre-fractionator section and a main fractionator section, and the dividing wall column may include a bottoms product feed to a primary absorber.

In some examples, the dividing wall column may include an overhead C3/C4 product stream, a main-fractionator side stream that is the aromatics-free C5/C6-rich product stream; and a bottoms product feed is directed to a hydrotreater.

In examples, the bottoms product feed may be a cracked natural gasoline blendstock.

In examples, there is provided an apparatus including a Low Pressure (LP) Depropanizer and/or a Debutanizer implementing a dividing wall column. The dividing wall column having a feed section, a top section, a bottom section, and a side draw section. The feed section may be configured to receive and to partially fractionate C3 and heavies hydrocarbon stream. The top section may be configured to fractionate top product components from middle product components and to produce the first hydrocarbon fraction process stream containing C3 hydrocarbons. The side draw section may be configured to fractionate the second hydrocarbon fraction process stream containing C4 hydrocarbons and the bottom section may be configured to fractionate bottom product components from middle product components and to produce a natural gasoline (NG) product stream.

Examples described herein may provide one or more of: steady production of the light olefins, improvement on fractionation efficiency, reduced utility requirements, and reduced overall energy requirements.

Examples described herein may provide one or more of: 20-30% less capital requirement as compared to the conventional column solution, less plot space (footprint) requirement. Thus, the embodiments herein achieve the application of dividing wall column (DWC) which offers capital expenditure (CAPEX) benefits (less equipment count and plot space benefits) and operational expenditure (OPEX) benefits (lower energy requirement) as compared to the route shown in FIG. 1.

### BRIEF DESCRIPTION OF THE DRAWINGS

So that the recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a process of conventional separation scheme for steam cracking and recovery of hydrocarbons;

FIG. 2 is a block flow diagram illustrating separation of hydrocarbons by a dividing wall column, according to an embodiment as described herein;

FIG. 3 is schematic representation of a dividing wall separation column according to an embodiment as described herein; and

FIG. 4 is a block diagram illustrating a dividing wall column being implemented in a separation scheme for selective cracking and recovery of hydrocarbons, according to an embodiment as described herein.

### DETAILED DESCRIPTION

A suitable heavy hydrocarbon feedstock can be catalytically cracked and the effluent resulting therefrom may be processed using a dividing wall column. In examples, it may be possible to produce or form one or more hydrocarbon product streams having desired purity of the hydrocarbon products. In examples, the product streams may be achieved in a manner that is more energy and capital cost efficient that existing processes.

It has been discovered that a dividing wall column can be used as a fractionator and simultaneously to separate various other products depending on cracking reactor effluent composition. Dividing wall column configurations which can be used as a fractionator in a catalytic olefins process are presented and discussed herein.

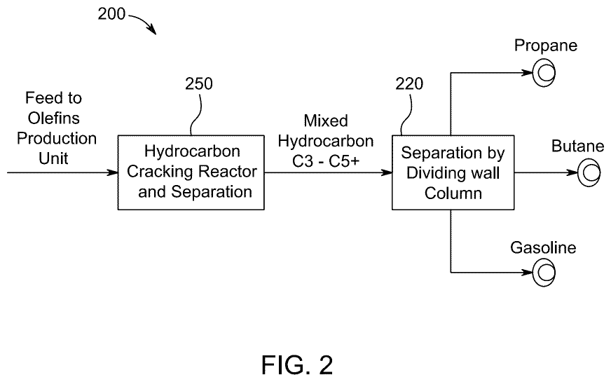

FIG. 2 is a block flow diagram illustrating separation of hydrocarbons by a dividing wall column as described herein. A hydrocarbon cracking system 200 as depicted in FIG. 2 may be configured for cracking a heavy hydrocarbon feedstock and obtaining selected hydrocarbon fractions from the effluent resulting therefrom, in accordance with one embodiment of the invention. In this context, a heavy hydrocarbon feedstock is considered as the one with more than 6 carbon atoms and light hydrocarbon feedstock is considered as the one with 1 to 6 carbon atoms It is to be understood that no unnecessary limitation to the scope of the claims which follow is intended by the following description. Those skilled in the art and guided by the teachings herein provided will recognize and appreciate that the illustrated system or process flow diagram has been simplified by the elimination of various usual or customary pieces of process equipment including some heat exchangers, process control systems, pumps, fractionation systems, and the like. It may also be discerned that the process flow depicted in the figure may be modified in many aspects without departing from the basic overall concept of the invention.

More specifically as shown in FIG. 2 is a hydrocarbon separation system 200 may include a steam cracking reactor and separator 210 sometimes simply called a reactor herein, that receives hydrocarbon feed and produces an effluent ultimately to a dividing wall separation column 220 which separates the effluent.

In some embodiments, the dividing wall column may include a feed section, a top section, a bottom section and a side draw section.

A feed stream may be introduced into the column on the feed section of the dividing wall section of the column. The feed stream separates through repeated fractionation into at least three different product streams. One of these may be removed from the side draw section opposite the feed section. The other two product streams are removed near the top and bottom sections of the column similar to a conventional column configuration and operation.

The feed section may be one side of a bifurcated middle section. In examples, the feed section may be configured to be the side of a bifurcated middle section that receives the introduced feed. The upper portion of the feed section may be in direct fluid contact with the top section. In examples, the upper portion of the feed section may receive liquid from and/or pass vapor to the top section. The lower portion of the feed section may be in direct fluid contact with the bottom section, In examples, the lower portion of the feed section may receive vapor from and/or pass liquid to the bottom section.

In examples, the feed section may be configured to receive the feed stream and to make the initial separation of the top product components from the bottom product components using a feed distributor. In examples, the feed distributor may include one or more feed vapor chimneys for directing the vapor fraction from the introduced feed as well as allowing the vapor fraction passing up the feed section from lower in the column to move further up.

In an embodiment, the feed section may be configured to receive and to partially fractionate an introduced mixed C3 to C5+ hydrocarbon stream. The top section may be configured to fractionate top product components from middle product components and to produce the first hydrocarbon fraction process stream containing C3 hydrocarbons.

The side draw section may be the other side that passes the middle product components of the dividing wall column. The upper portion of the side draw section may be in direct fluid contact with the top section. In examples, the upper portion of the side draw section may receive liquid from and passes vapor to the top section. The lower portion of the side draw section may be in fluid contact with the bottom section. In examples, the lower portion of the side draw section may receive vapor from and passes liquid to the bottom section

The side draw section may be configured to fractionate the second hydrocarbon fraction process stream containing C4 hydrocarbons. The side draw section may be configured to receive the middle product components descending from the top section and ascending from the bottom section. As well, the side draw section may separate the middle product components from both the top product components that may drift down from the top section and the bottom product components that may rise up from the bottom section and the bottom section may be configured to fractionate bottom product components from middle product components and to produce a natural gasoline (NG) product stream.

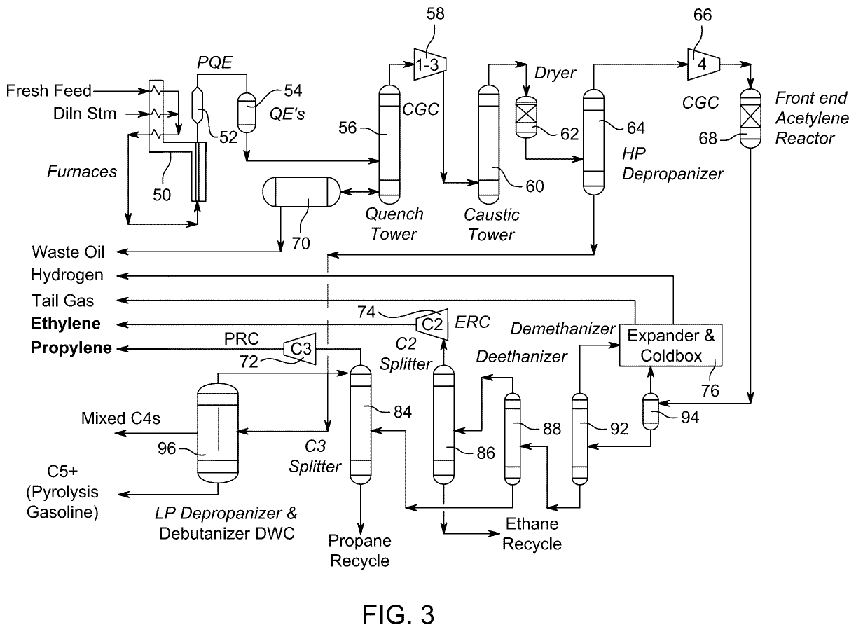

FIG. 3 is a simplified schematic representation of a dividing wall separation column 120 in accordance with one embodiment. FIG. 3 shows a LP depropanizer/debutanizer that implements a dividing wall separation column. The dividing wall separation column 120 includes a dividing wall 100 positioned therewithin and desirably includes a plurality of stages (not specifically shown) and is generally composed of central or middle dividing wall section, generally designated by the reference numeral 85, as well as an upper or top section 90 and a lower or bottom section 95 In examples, central or middle dividing wall section 85 may include a bifurcated section. In examples, the central or middle dividing wall section 85 may include a feed section on one side of the bifurcated section and output stream section (i.e., for C5 stream) on the other side of the bifurcated section. As shown, the upper section 90 may desirably be of reduced internal diameter as compared to the central dividing wall section 85 and the lower section 95 may desirably be of increased diameter as compared to the central dividing wall section 85.

In accordance with a preferred embodiment and as shown, the mixed hydrocarbon feed stream can desirably be introduced via a line 80 into the central dividing wall section 85. A light fraction, i.e., propane (C3) in accordance with a preferred embodiment, may be withdrawn from the upper or top section 90 as shown in FIG. 3. An intermediate fraction, i.e., butane (C4) in accordance with a preferred embodiment, can be withdrawn as a side product from the central or middle section 85, i.e., on the right side of the middle dividing wall section 85 as shown in the FIG. 3. A heavy fraction i.e., gasoline, in accordance with a preferred embodiment, can be withdrawn from the lower or bottom section 95.

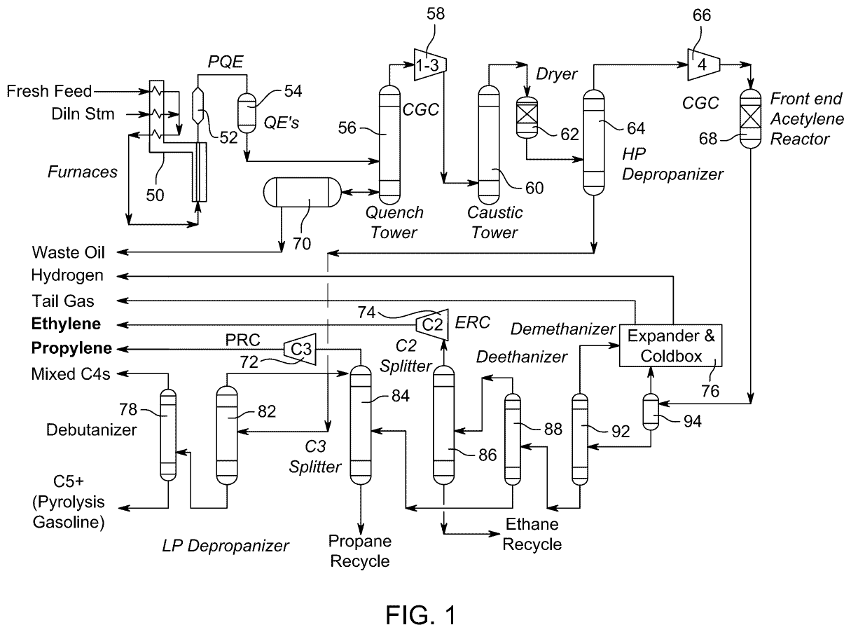

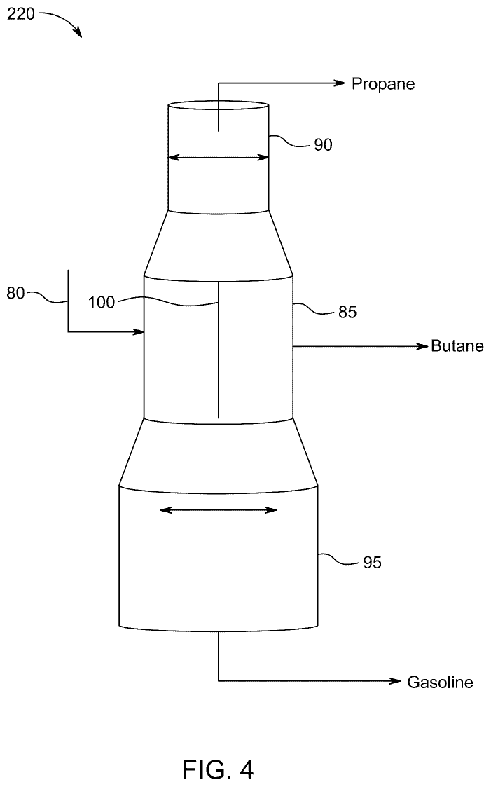

FIG. 4 is a block diagram illustrating a dividing wall column being implemented in a separation scheme for selective cracking and recovery of hydrocarbons, according to an embodiment as described herein. The LP depropanizer 82 and the debutanizer 78 as illustrated in FIG. 1 are implemented as a single fractionation column 96 as shown in the FIG. 4.

The steam cracking reactor can be used together with the dividing wall column to achieve one or of more of: improved efficiency, reduced utility and energy requirements, reducing CO₂ and/or NOx emissions, enhancing plant safety, reducing iso-butane loss, reducing capital requirements.

Thus, the dividing wall column along with steam cracking reactor performs the efficient hydrocarbon separation wherein the diving wall including a top section may be configured to fractionate top product components from middle product components and to produce the first hydrocarbon fraction process stream containing C3 hydrocarbons. A side draw section may be configured to fractionate the second hydrocarbon fraction process stream containing C4 hydrocarbons and the bottom section may be configured to fractionate bottom product components from middle product components and to produce a natural gasoline (NG) product stream.

Therefore, the usage of the DWC together with steam cracking reactor as shown in the FIG. 4, achieves efficient separation of hydrocarbons. Unlike the existing systems which use two column design as shown in the FIG. 1 for hydrocarbon separation, the usage of the DWC together with steam cracking reactor can achieve significant capital gains and energy requirements, reduced CO₂ and/or NOx emissions.

The single fractionation column may be implemented as a dividing wall column as shown in the FIG. 3. Thus, the dividing wall column is used together with steam cracking reactor for catalytic cracking of olefins and for efficient separation of hydrocarbons using the dividing wall column.

The Dividing Wall Column (DWC) technology which can be used to further improve and simplify the process flow scheme (as shown schematically in FIG. 1) for olefins productions by the cracking unit. Dividing Wall Column technology delivers the performance of two conventional columns in series in a single column with reduced energy and capital requirement. Dividing Wall Column technology can be used to design a single column to replace the two columns i.e., the LP depropanizer 82 and the debutanizer 78 as illustrated in FIG. 1) in series system as shown in the FIG. 4 embodiment.

The single fractionation column 96 (which can be the LP depropanizer 82 and/or the debutanizer 78) implements a dividing wall column having a feed section, a top section, a bottom section, and a side draw section. Thus, the LP depropanizer 82 and/or the debutanizer 78 as illustrated in FIG. 1 are integrated to form a single fractionation column 96 which has a dividing wall. The top section is configured to fractionate top product components from middle product components and to produce the first hydrocarbon fraction process stream containing C3 hydrocarbons. The side draw section configured to fractionate the second hydrocarbon fraction process stream containing C4 hydrocarbons and the bottom section is configured to fractionate bottom product components from middle product components and to produce the NG product stream.

Thus, through the incorporation and use of dividing wall separation column as herein described, the invention provides desired product splits for reactor effluent processing and does so in a generally more energy efficient manner than heretofore has been realized in the processing of such effluent streams.

It should be noted that that other configurations and variations of the dividing wall column shown in the FIG. 3 are possible, for example the dividing wall column can be a Top dividing wall column and the dividing wall column can have different product draw offs and combinations thereof compared to the embodiment shown in the FIG. 3.

In some embodiments, the DWC 120 may include a pre-fractionator section and a main fractionator section divided by dividing wall. Further, the DWC 120 may include a side draw that is the aromatics-free C5/C6-rich product stream and the DWC 120 may include a bottoms product feed to a primary absorber.

In another embodiment, the dividing wall column may include an overhead C3/C4 product stream, a main-fractionator side stream that is the aromatics-free C5/C6-rich product stream and a bottoms product feed directed to a hydrotreater. The bottoms product feed is a cat-cracked naphtha gasoline blendstock.

A simulation study was conducted to compare the performance of two conventional columns such as the debutanizer column 78 and the LP depropanizer column 82 (as described in FIG. 1) versus the dividing wall column. It has been observed that there is 21% reduction in total condenser duty and 16% reduction in total reboiler duty while using the divided wall column compared to the conventional two column design described in the FIG. 1.

The words “comprising” and “comprises” as used throughout the claims, are to be interpreted to mean “including but not limited to” and “includes but not limited to”, respectively.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and considers experimental error and variations that would be expected by a person having ordinary skill in the art. Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A hydrocarbon separation system comprising:
a cracking reactor configured to receive a hydrocarbon feed and to produce an effluent;
a dividing wall column, wherein the dividing wall column having a feed section, a top section, a bottom section, and a side draw section,
where the feed section is configured to receive and to partially fractionate C3 and heavies hydrocarbon stream,
wherein the top section is configured to fractionate top product components from middle product components and to produce a first hydrocarbon fraction process stream containing C3 hydrocarbons,
wherein the side draw section configured to fractionate a second hydrocarbon fraction process stream containing C4 hydrocarbons, and
where the bottom section is configured to fractionate bottom product components from middle product components and to produce a natural gasoline (NG) product stream.

2. The hydrocarbon separation system of claim 1, wherein the dividing wall column having an operating pressure from 8 bars to 3 bars.

3. The hydrocarbon separation system of claim 1, wherein the dividing wall column comprising a pre-fractionator section and a main fractionator section; and the dividing wall column comprises a bottoms product feed to a primary absorber.

4. The hydrocarbon separation system of claim 3, wherein the dividing wall column comprises an overhead C3/C4 product stream, a main-fractionator side stream that is the aromatics-free C5/C6-rich product stream; and a bottoms product feed directed to a hydrotreater.

5. The hydrocarbon separation system of claim 4, wherein the bottoms product feed is a cracked natural gasoline blendstock.

6. A process for separating hydrocarbon feed, the process comprising:
introducing a hydrocarbon feed to a cracking reactor to produce an effluent;
fractionating the effluent using a dividing wall column, wherein the dividing wall column having a feed section, a top section, a bottom section, and a side draw section; and
operating the dividing wall column such that C3 and heavies hydrocarbon stream passes from the feed section, a first hydrocarbon fraction process stream containing C3 hydrocarbons passes from the top section, a second hydrocarbon fraction process stream containing C4 hydrocarbons passes from the side draw section, and a natural gasoline (NG) product stream passes from the bottom section.

7. The process of claim 6, wherein the dividing wall column is operated with an operating pressure from 8 bars to 3 bars.

8. The process of claim 6, wherein the dividing wall column comprising a pre-fractionator section and a main fractionator section, and the dividing wall column comprises a bottoms product feed to a primary absorber.

9. The process of claim 8, wherein the dividing wall column comprises an overhead C3/C4 product stream, a main-fractionator side stream that is the aromatics-free C5/C6-rich product stream; and a bottoms product feed is directed to a hydrotreater.

10. The process of claim 9, wherein the bottoms product feed is a cracked natural gasoline blendstock.

11. An apparatus, comprising:
a dividing wall column, wherein the dividing wall column having a feed section, a top section, a bottom section, and a side draw section,
where the feed section is configured to receive and to partially fractionate C3 and heavies hydrocarbon stream,
wherein the top section is configured to fractionate top product components from middle product components and to produce the first hydrocarbon fraction process stream containing C3 hydrocarbons,
wherein the side draw section configured to fractionate the second hydrocarbon fraction process stream containing C4 hydrocarbons, and
where the bottom section is configured to fractionate bottom product components from middle product components and to produce a natural gasoline (NG) product stream.

12. The apparatus of claim 11, wherein the LP depropanizer and/or the debutanizer implementing the dividing wall column having an operating pressure from 8 bars to 3 bars.

13. The apparatus of claim 12, wherein the dividing wall column comprising a pre-fractionator section and a main fractionator section, and the dividing wall column comprises a bottoms product feed to a primary absorber.

14. The apparatus of claim 13, wherein the dividing wall column comprises an overhead C3/C4 product stream, a main-fractionator side stream that is the aromatics-free C5/C6-rich product stream; and a bottoms product feed directed to a hydrotreater.

15. The apparatus of claim 14, wherein the bottoms product feed is a cracked natural gasoline blendstock.
